(19) United States
(12) Patent Application Publication
(10) Pub. No.: US 2015/0248472 A1
(43) Pub. Date: Sep. 3, 2015

(54) CLUSTERING METHOD, APPARATUS, AND TERMINAL APPARATUS

(71) Applicant: Xiaomi Inc., Beijing (CN)

(72) Inventors: Zhijun CHEN, Beijing (CN); Tao ZHANG, Beijing (CN); Lin WANG, Beijing (CN)

(73) Assignee: Xiaomi Inc.

(21) Appl. No.: 14/606,611

(22) Filed: Jan. 27, 2015

Related U.S. Application Data
(63) Continuation of application No. PCT/CN2014/091197, filed on Nov. 14, 2014.

(30) Foreign Application Priority Data
Feb. 28, 2014 (CN) 201410073496.5

(51) Int. Cl. G06F 17/30

(52) U.S. Cl. CPC G06F 17/30598; G06F 17/30312

(57) ABSTRACT

A clustering method includes obtaining neighbor objects of an object to be visited. The object to be visited has a plurality of neighborhood domains. The method further includes determining whether a number of neighbor objects in at least one of the neighborhood domains is larger than or equal to a predetermined value, clustering the object to be visited into a group if the number of neighbor objects in the at least one of the neighborhood domains is larger than the predetermined value, and performing a cluster expansion on directly density-reachable objects in a predetermined neighborhood domain of the object to be visited.

### CROSS-REFERENCE TO RELATED APPLICATIONS

This application is a Continuation of International Patent Application No. PCT/CN2014/091197, filed Nov. 14, 2014, which claims the benefit of prior Chinese Application No. 201410073496.5 filed Feb. 28, 2014, the entire contents of both of which are incorporated herein by reference.

### TECHNICAL FIELD

Embodiments of the present disclosure relate to computer technology and, more particularly, to a method, apparatus, and terminal apparatus for clustering.

### BACKGROUND

Clustering is a process of dividing a set of physical or abstract objects into a plurality of groups of analogous objects, i.e., a process of dividing the objects into different groups or clusters, in which the objects in a same group have large similarities and the objects in different groups have large differences.

There are many types of clustering methods, including, for example, clustering methods based on density and clustering methods based on various distances. With the clustering methods based on density, if the density of dots in a domain is larger than a predetermined threshold, the domain is added into a similar group. Thus, the cluster methods based on density can avoid the problem of only finding “quasi-circular” groups that is common to cluster methods based on distance. For example, Density-Based Spatial Clustering of Applications with Noise (DBSCAN) algorithm is a typical clustering algorithm based on density. The DBSCAN algorithm defines the cluster as a maximum set of dots having connected densities, which can divide the domain having a high enough density into the cluster and find the cluster of any shape in a spatial database of noise. The DBSCAN algorithm introduces a concept of core object and two initial parameters—Eps (scanning radius) and MinPts (minimum number of contained dots). If the number of objects within a range of Eps around a certain object is larger than or equal to MinPts, that certain object is a core object. The core object and the neighbor objects within the range of Eps around the core object form a cluster. If there are a plurality of core objects in the cluster, the clusters centered on these core objects are combined together. However, a clustering result of this clustering method is very sensitive to values of the parameters Eps and MinPts, i.e., different values of Eps and MinPts may cause different clustering results, resulting in uncertainty of the clustering result.

### SUMMARY

In accordance with the present disclosure, there is provided a clustering method. The method includes obtaining neighbor objects of an object to be visited. The object to be visited has a plurality of neighborhood domains. The method further includes determining whether a number of neighbor objects in at least one of the neighborhood domains is larger than or equal to a predetermined value, clustering the object to be visited into a group if the number of neighbor objects in the at least one of the neighborhood domains is larger than the predetermined value, and performing a cluster expansion on directly density-reachable objects in a predetermined neighborhood domain of the object to be visited.

Also in accordance with the present disclosure, there is provided a clustering apparatus. The clustering apparatus includes an obtaining unit configured to obtain neighbor objects of an object to be visited, a judging unit configured to determine whether a number of neighbor objects in at least one of the neighborhood domains is larger than or equal to a predetermined value, a clustering unit configured to cluster the object to be visited into a group if the number of neighbor objects in the at least one of the neighborhood domains is larger than the predetermined value, and a cluster expanding unit configured to perform a cluster expansion on directly density-reachable objects in a predetermined neighborhood domain of the object to be visited.

Also in accordance with the present disclosure, there is provided a terminal apparatus. The terminal apparatus includes a processor and a non-transitory computer-readable storage medium storing instructions. The instructions, when executed by the processor, cause the processor to obtain neighbor objects of an object to be visited having a plurality of neighborhood domains, determine whether a number of neighbor objects in at least one of the neighborhood domains is larger than or equal to a predetermined value, cluster the object to be visited into a group if the number of neighbor objects in the at least one of the neighborhood domain is larger than the predetermined value, and perform a cluster expansion on directly density-reachable objects in a predetermined neighborhood domain of the object to be visited.

Also in accordance with the disclosure, there is provided a non-transitory computer-readable storage medium storing instructions. The instructions, when executed by a processor of a mobile terminal, cause the mobile terminal to obtain neighbor objects of an object to be visited having a plurality of neighborhood domains, determine whether a number of neighbor objects in at least one of the neighborhood domains is larger than or equal to a predetermined value, cluster the object to be visited into a group if the number of neighbor objects in the at least one of the neighborhood domain is larger than the predetermined value, and perform a cluster expansion on directly density-reachable objects in a predetermined neighborhood domain of the object to be visited.

It should be understood that, both the general description above and the detailed description below are merely exemplary and explanatory, and do not limit the present disclosure.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart of a clustering method according to an exemplary embodiment of the present disclosure.

FIG. 2 is a schematic diagram of an object distribution according to an exemplary embodiment of the present disclosure.

FIG. 3 is a schematic diagram of a neighborhood domain distribution according to an exemplary embodiment of the present disclosure.

FIG. 4 is a flow chart of a method of cluster expansion according an exemplary embodiment of the present disclosure.

FIG. 5 is a flow chart of a method for determining whether there exists at least one neighborhood domain in which a number of neighbor objects is larger than or equal to a predetermined value, according an exemplary embodiment of the present disclosure.

FIG. 6 is a flow chart of a method for determining whether there exists at least one neighborhood domain in which a number of neighbor objects is larger than or equal to a predetermined value, according another exemplary embodiment of the present disclosure;

FIG. 7 is a flow chart of a method for obtaining a weight coefficient according to an exemplary embodiment of the present disclosure.

FIG. 8 is a schematic diagram of a clustering apparatus according to an exemplary embodiment of the present disclosure.

FIG. 9 is a block diagram of an apparatus according to an exemplary embodiment of the present disclosure.

### DESCRIPTION OF THE EMBODIMENTS

Embodiments consistent with the present disclosure include a method, apparatus, and terminal for clustering.

Consistent with the present disclosure, certain terms are defined as follows.

E neighborhood domain: a domain centered on a certain object and having a scanning radius E is referred to as an E neighborhood domain of the object.

Core object: if the number of neighbor objects in an E neighborhood domain of an object P is larger than or equal to a minimum contained object threshold, MinPts, the object P is referred to as a core object.

Neighbor object: an object able to be connected with an object P directly is referred to as a neighbor object of the object P.

Directly density-reachable: for a sample set, if a neighbor object Q is in an E neighborhood domain of an object P and the object P is a core object, then the object Q is directly density-reachable from the object P, i.e., the object Q is a neighbor object of the object P in the E neighborhood domain.

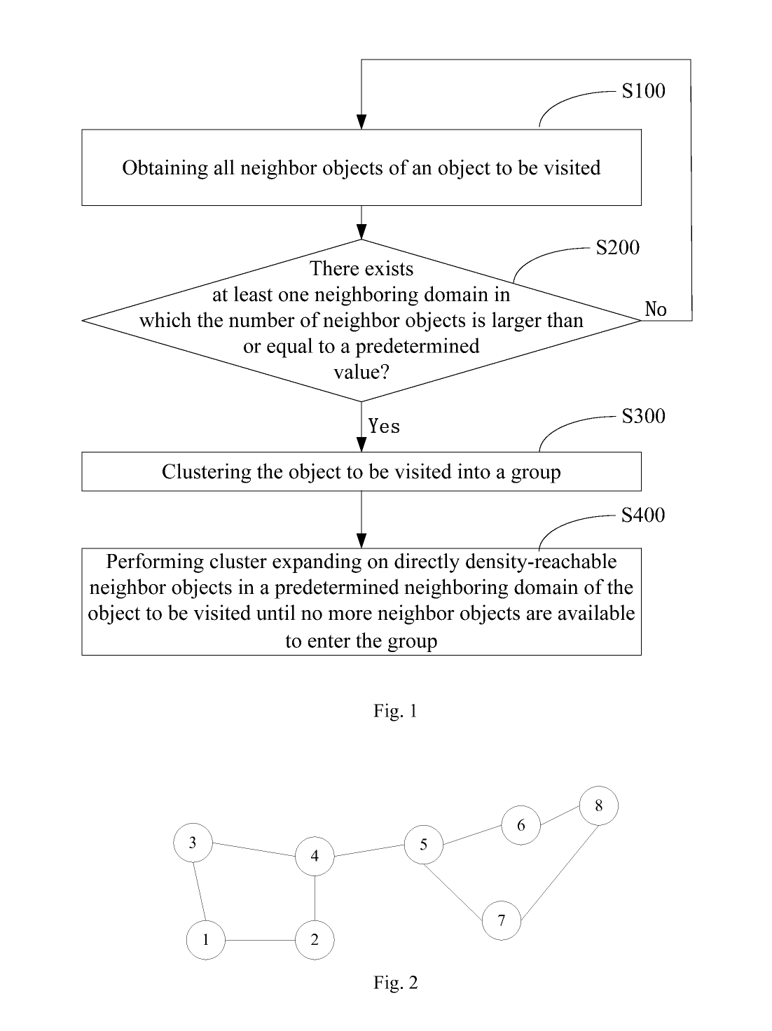

FIG. 1 is a flow chart of an exemplary clustering method consistent with embodiments of the present disclosure. As shown in FIG. 1, at S100, all neighbor objects of an object to be visited are obtained. Objects may be face images of humans, and images belonging to a same person are clustered to form a cluster. Features in a face image are transformed into a vector, and thus a distance between two objects is a distance between the vectors corresponding to the two objects. In some embodiments, the objects may include data other than images.

For a set of objects to be processed, each object in the set is treated as the object to be visited and all neighbor objects of the object to be visited are obtained. As shown in FIG. 2, object 5 is directly connected with objects 4, 6, and 7, and thus objects 4, 6, and 7 are neighbor objects of object 5.

A visiting identification is set for each object. When a certain object is visited, the visiting identification of the object is marked as visited. For example, if a certain object has not been visited, the corresponding visiting identification is “0”. If that object has been visited, the corresponding visiting identification is changed to “1”. Thus, the visiting identification can be used to determine whether the object is an object to be visited.

Consistent with the present disclosure, the object to be visited has a plurality of neighborhood domains. At S200, it is determined whether there exists at least one neighborhood domain in which the number of neighbor objects of the object to be visited is larger than or equal to a predetermined value. This determines whether the object to be visited is a core object. If there exists at least one such neighborhood domain (S200: “Yes”), the process proceeds to S300. Otherwise (S200: “No”), the object to be visited is marked as a noise dot and S100 is executed on a next object to be visited, until no more objects to be visited exist.

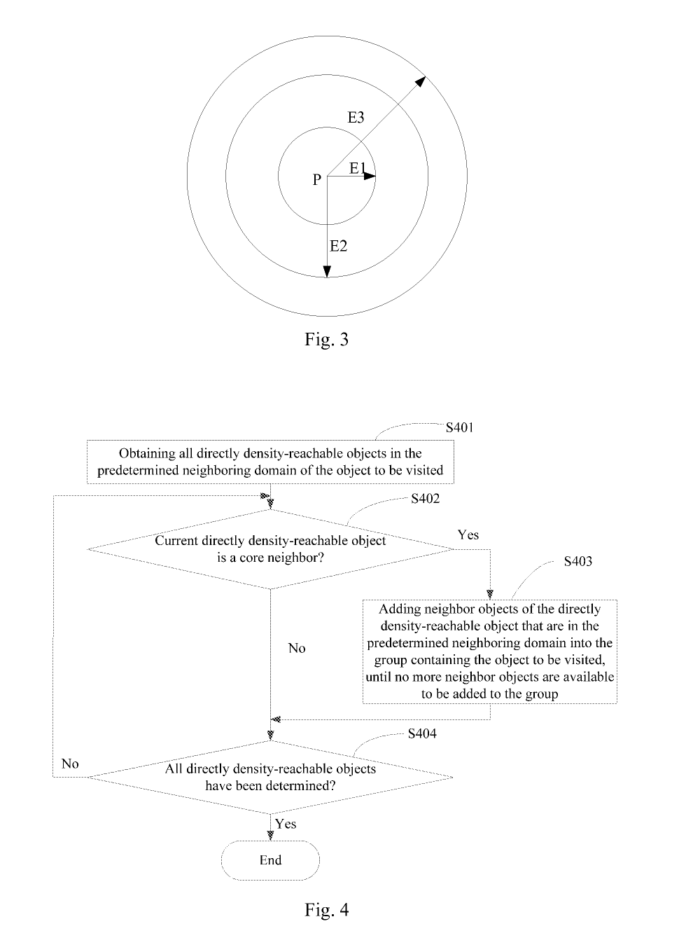

For example, as shown in FIG. 3, the object to be visited, P, has three neighborhood domains—an E1 neighborhood domain having a scanning radius of E1, an E2 neighborhood domain having a scanning radius of E2, and an E3 neighborhood domain having a scanning radius of E3, where E1<E2<E3. It is first determined whether the number Pts1 of neighbor objects of the object P in the E1 neighborhood domain is larger than or equal to MinPts1, i.e., whether Pts1≧MinPts1. If so, the object P is determined to be a core object. Otherwise, it is further determined whether the number Pts2 of neighbor objects of the object P in the E2 neighborhood domain is larger than or equal to MinPts2, i.e., whether Pts2≧MinPts2. If so, the object P is determined to be a core object. Otherwise, it is further determined whether the number Pts3 of neighbor objects of the object P in the E3 neighborhood domain is larger than or equal to MinPts3, i.e., whether Pts3≧MinPts3. If so, the object P is determined to be a core object. Otherwise, the object P is determined to not be a core object. The scanning radii may be set according to different characteristics of a data type of the object.

Referring to FIG. 1, at S300, the object to be visited is clustered into one group, i.e., the object to be visited is treated as a group. A group number C is set for the object. In an initial state, the group number C is 0. Each time one group is added, the largest group number in the existing groups is increased by 1 and assigned to the added group. For example, if the object P is a core object, the object P is clustered into one group and the group number C corresponding to that group is 1. If a core object Q that does not belong to the group containing the object P is found, the core object Q is clustered into another group and the group number corresponding to the other group is set to be 2. That is, the group number of the added group is a number equal to the largest group number of the existing group(s) plus 1.

At S400, a cluster expansion is performed on directly density-reachable objects in a predetermined neighborhood domain of the object to be visited, i.e., the group containing the object P is expanded by including the directly density-reachable objects, until no more neighbor objects are available to enter the group. The predetermined neighborhood domain may be one or more of the plurality of neighborhood domains of the object to be visited, such as the neighborhood domains shown in FIG. 3. If the neighborhood domain having a larger scanning radius has a lower credibility, then the cluster expansion can be performed only on the objects in the neighborhood domains having a higher credibility. For example, in the example shown in FIG. 3, the cluster expansion can be performed only on the neighbor objects in the E1 neighborhood domain and the E2 neighborhood domain of the object P. On the other hand, if each of the plurality of neighborhood domains has a high credibility, the cluster expansion can be performed on the neighbor objects in all of neighborhood domains.

FIG. 4 shows an exemplary method of cluster expansion (S400 in FIG. 1). As shown in FIG. 4, at S401, all directly density-reachable objects in the predetermined neighborhood domain of the object to be visited are obtained. The scanning radius of the predetermined neighborhood domain is smaller than a maximum scanning radius of the plurality of neighborhood domains. With a larger scanning radius, the probability of bringing in noise dots is larger. Thus, the directly density-reachable objects in the predetermined neighborhood domain are added into the group that contains the object to be visited.

A queue NeighborPts including all the neighbor objects of the object P to be visited that are in the predetermined neighborhood domain is obtained. To determine whether a neighbor object belongs to the queue NeighborPts, the distance between the neighbor object and the object P to be visited is calculated directly, and the calculated distance is compared with the scanning radius of the predetermined domain. If the distance is larger than or equal to the scanning radius, then the neighbor object is an object in the queue NeighborPts. The distance may be, for example, a cosine similarity or a Euclidean distance. In the present disclosure, to indicate a distance relationship between two objects, the cosine similarity between the two objects is not directly used. Instead, a difference (1−cos θ) between one and the cosine similarity is used to represent the distance between the two objects. As such, the shorter the distance between the two objects is, the higher the similarity between the two objects is.

In some embodiments, after the distance between each neighbor object and the object to be visited is obtained, the distances are sequenced according to values of the distances. Based on this sequence, neighbor objects having a distance to the object to be visited less than the scanning radius of the predetermined neighborhood domain are counted to form the queue NeighborPts.

The directly density-reachable objects are checked one by one, i.e., all objects in the queue NeighborPts are traversed, to determine whether they are core objects. At S402, a current directly density-reachable object is checked. The process of determining whether the directly density-reachable object is a core object is similar to that in S200. That is, for any directly density-reachable object, it is determined whether there exists at least one neighborhood domain (of the directly density-reachable object) in which the number of neighbor objects (of the directly density-reachable object) is larger than or equal to the predetermined value. If so, the directly density-reachable object is determined to be a core object. If the number of neighbor objects in each neighborhood domain of the directly density-reachable object is smaller than the predetermined value, the directly density-reachable object is determined to not be a core object.

If the directly density-reachable object is a core object (S402: “Yes”), then the neighbor objects of the directly density-reachable object that are in the predetermined neighborhood domain are added into the group containing the object to be visited, until no more new objects are available to be added to the group (S403).

In some embodiments, during cluster expansion, a queue is created for the object to be visited. For example, when the cluster expansion is performed for the object P to be visited, a queue is created and the directly density-reachable objects of the object P that are in the predetermined neighborhood domain are added into the queue. For example, the queue may be {P1, P2, P3, P4}. First, it is determined whether P1 is a core object. If yes, directly density-reachable objects of P1 that are in the predetermined neighborhood domain are added into the group containing P and are also added into the queue (in a stack data structure). Then the next object (such as P2) in the queue is visited, and this object (P2) is marked as visited. It is determined whether this object is a core object. If this object is not a core object, it is determined whether it is a member of another group. If this object is not the member of another group, then it is added into the group containing the object P. Then a next object in the queue is visited until no object is left in the queue.

If the above-mentioned directly density-reachable object is not a core object, then at S404, it is determined whether all directly density-reachable objects have been determined. If not all the directly density-reachable objects have been determined, the process returns to S402. If all the directly density-reachable objects have been determined, the cluster expansion process ends.

Consistent with embodiments of the present disclosure, since a plurality of neighborhood domains are used to determine whether the object to be visited is a core object, a limitation of Eps (scanning radius) and MinPts (minimum number of contained dots) is reduced. Thus, a sensitivity of the clustering result to Eps and MinPts are reduced and an accuracy rate of the clustering result is improved.

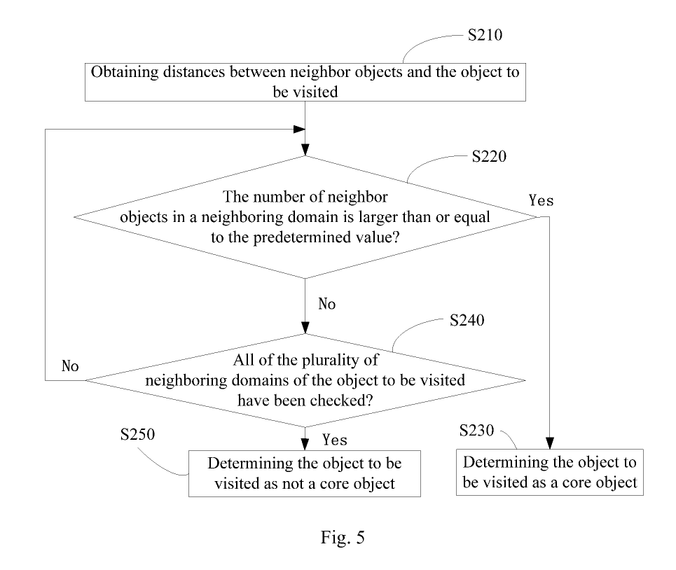

FIG. 5 schematically shows an exemplary method for determining whether there exists at least one neighborhood domain in which the number of neighbor objects is larger than or equal to the predetermined value (S200 in FIG. 1). As shown in FIG. 5, at S210, a distance between a neighbor object and the object to be visited is obtained for all the neighbor objects of the object to be visited. The distance may be, for example, the cosine similarity or the Euclidean distance.

In the present disclosure, a difference (1−cos θ) between one and the cosine similarity between two objects is used to represent the distance between the two objects. As such, the shorter the distance between the two objects is, the higher the similarity between the two objects is.

At S220, it is determined whether the number of neighbor objects in a neighborhood domain is larger than or equal to the predetermined value based on the distances of the neighbor objects. Consistent with the present disclosure, the plurality of neighborhood domains of the object to be visited are checked one by one in an ascending order of the scanning radii of the neighborhood domains. If the number of neighbor objects in the neighborhood domain being checked is larger than or equal to the predetermined value, the process proceeds to S230, at which the object to be visited is determined to be a core object. On the other hand, if the number of neighbor objects in the neighborhood domain being checked is smaller than the predetermined value, the process proceeds to S240.

In some embodiments, after the distance between each neighbor object and the object to be visited is obtained, the distances are sequenced according to the values of the distances. According to the obtained sequence, the number of neighbor objects having a distance to the object to be visited smaller than the scanning radius of the neighborhood domain is counted. Then, it is determined whether the number of the neighbor objects is larger than or equal to a corresponding predetermined threshold.

For the example shown in FIG. 3, the distances between the objects in the E1 neighborhood domain and the object P are sequenced according to the values of the distances, to obtain the distance sequence. The distance closest to the scanning radius E1 in the distance sequence may be determined according to a search method (such as a binary chop search method), and the number of the distances in the distance sequence that are smaller than the distance closest to the scanning radius E1 is counted to determine the number of the objects in the E1 neighborhood domain, thus improving a determination efficiency.

Moreover, to determine the number of neighbor objects in the E2 neighborhood domain, only a number Pts21 of the neighbor objects, whose distance to the object P is smaller than the scanning radius E2 and larger than the scanning radius E1, needs to be counted by searching the distance sequence. The number of neighbor objects in the E2 neighborhood domain is Pts21+Pts1. Similarly, a number Pts32 of the neighbor objects, whose distance to the object P is smaller than the scanning radius E3 and larger than the scanning radius E2, is counted by searching the distance sequence. The number of neighbor objects in the E3 neighborhood domain is Pts32+Pts21+Pts1. If there are more than three neighborhood domains, the number of the neighbor objects in those neighborhood domains can be obtained in a similar manner.

Consistent with the present disclosure, the plurality of neighborhood domains of the object P to be visited are checked in an ascending order of the scanning radii. Therefore, when the number of neighbor objects in a certain neighborhood domain is determined to be larger than or equal to the predetermined value, there is no need to continue determining the numbers of neighbor objects in other neighborhood domains.

Referring again to FIG. 5, at S240, it is determined whether all of the plurality of neighborhood domains of the object to be visited have been checked. If not (S240: “No”), the process returns to S220. Otherwise (S240: “Yes”), the process proceeds to S250, at which the object to be visited is determined to not be a core object.

To determine whether all neighborhood domains have been checked, for example, a variable i having an original value of 0 may be set. When the first neighborhood domain is checked, the variable i increases by 1 (i.e., i=i+1). Whether all neighborhood domains have been checked can be determined by comparing the variable i with the number of neighborhood domains.

If the object P to be visited is not a core object, then the object P is a noise dot. The process shown in FIG. 5 is repeated for a next object to be visited, until no object to be visited is left.

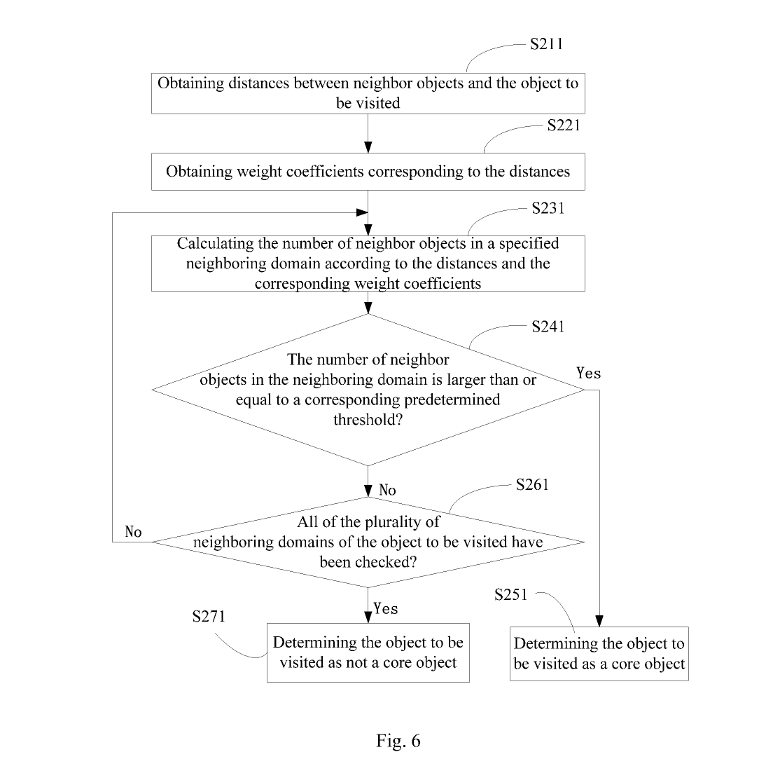

FIG. 6 schematically shows another exemplary method for determining whether there exists at least one neighborhood domain in which the number of neighbor objects is larger than or equal to the predetermined value (S200 in FIG. 1). As shown in FIG. 6, at S211, a distance d between a neighbor object and the object to be visited is obtained for all the neighbor objects of the object to be visited. S211 is similar to S210 shown in FIG. 5 and thus details thereof are not repeated here.

At S221, a weight coefficient W(d) corresponding to each distance d is obtained. The weight coefficient of a distance is related to the distance and the similarity between the corresponding neighbor object and the object to be visited. Consistent with the present disclosure, the weight coefficient of a distance can reflect the relationship between the distance and the similarity between the corresponding two objects. For example, the longer the distance is, the lower the similarity is and thus the smaller the corresponding weight coefficient is. Conversely, the shorter the distance is, the higher the similarity is and thus the greater the corresponding weight coefficient is.

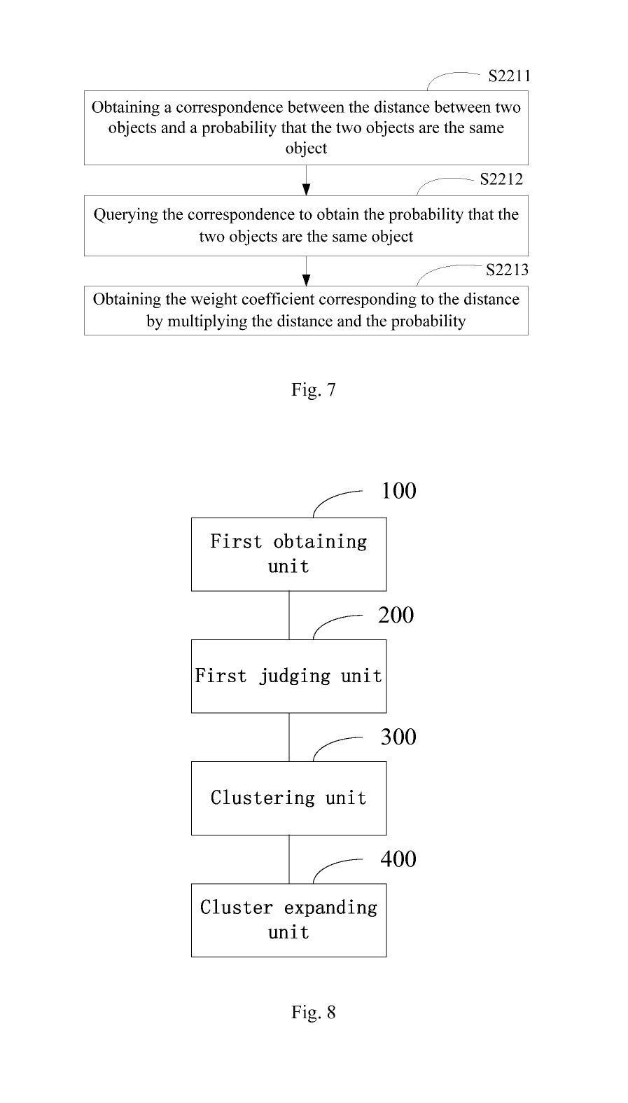

In some embodiments, the weight coefficient of a distance between two objects may be determined by the distance and the probability that the two objects are the same object. FIG. 7 schematically shows an exemplary method for obtaining the weight coefficient.

As shown in FIG. 7, at S2211, for a distance between two objects, a correspondence between the distance and a probability that the two objects are the same object is obtained according to sample object statistics. The distance between two objects can be expressed in terms of, for example, the cosine similarity or the Euclidean distance. For example, for two objects A and B, the cosine similarity between the two objects can be calculated according to formula (1):

$$cos θ = \frac{A \cdot B}{\vert \vert A \vert \vert B \vert \vert} \qquad ( 1 )$$

where A·B is an inner product of vector A and vector B, |A| is a length of vector A, and |B| is a length of vector B.

For example, in face recognition, the cosine similarity cos θ between two face images calculated according to high-dimensional features is in a range of [0, 1]. Face image statistic data show that, if the cosine similarity is in a range of [0.4, 1], the probability that the two objects are the same person is about 98%; if the cosine similarity is in a range of [0.35, 0.4], the probability that the two objects are the same person is about 90%; if the cosine similarity is in a range of [0.3, 0.35], the probability that the two objects are the same person is about 70%; if the cosine similarity is in a range of [0.25, 0.3], the probability that the two objects are the same person is about 40%; and if the cosine similarity is in a range of [0, 0.25], the probability that the two objects are the same person is about 10%.

The correspondence between the distance between two objects and the probability that the two objects are the same object may be stored in a table or in another form.

At S2212, the correspondence is queried to obtain the probability that the two objects corresponding to the distance are the same object.

At S2213, the weight coefficient corresponding to the distance is obtained by multiplying the distance and the probability. The weight coefficient is in a positive correlation with the probability.

In the human face recognition example described above, the relationship between the weight coefficient and the cosine similarity may be described using formula (2):

$$W ( d ) = \{ \begin{matrix}1 * cos θ , if cos θ \geq 0.45 \\ 0.7 * cos θ , if 0.35 \leq cos θ \leq 0.45 \\ 0.4 * cos θ , if 0.25 \leq cos θ \leq 0.35 \\ 0.1 * cos θ , if 0.15 \leq cos θ \leq 0.25 \\ 0.001 * cos θ , if cos θ < 0.15\end{matrix} \qquad ( 2 )$$

For other types of distances, a relationship expression may be summarized and derived according to the correspondence between the distance and the corresponding probability, the details of which are omitted here.

In some embodiments, the weight coefficient can be obtained by other means, as long as the weight coefficient represents the relation between the distance between two objects and the similarity between the two objects.

Referring again to FIG. 6, at S231, the number of neighbor objects in a specified neighborhood domain is calculated according to the weight coefficients and the distances.

In some embodiments, after the distance between each neighbor object and the object to be visited is obtained, the distances are sequenced according to the values of the distances. According to the distance sequence, the number of neighbor objects, whose distance to the object to be visited is smaller than the scanning radius of the neighborhood domain, is counted. Then, according to the distance between the neighbor object in the specified neighborhood domain and the object to be visited, and the corresponding weight coefficient, the number of neighbor objects in the E neighborhood domain is calculated.

The specified neighborhood domain may be any one of the plurality of neighborhood domains of the object to be visited. The neighborhood domains are checked in the ascending order of the scanning radii thereof.

The number of neighbor objects can be represented using formula (3):

$$Pts = {\sum }_{i ∈ E} W ( {d}_{i} ) \qquad ( 3 )$$

where W(dᵢ) represents the weight coefficient corresponding to a distance di between a neighbor object and the object to be visited. In the face recognition example, W(dᵢ) can be calculated using formula (2) described above.

Formula (3) represents a total number of all the objects in the E neighborhood domain taking into consideration the corresponding weight coefficients. That is, the number of a certain object is changed from the actual number one to the weight coefficient W(dᵢ) corresponding to the distance between the certain object and the object to be visited. In other words, instead of calculating the actual number of objects in the E neighborhood domain, the objects closer to the center point are assigned larger weight coefficients and thus contribute more to the final converted total number of objects, while the objects farther away from the center point are assigned smaller weight coefficients and thus contribute less to the final converted total number of objects.

At S241, it is determined whether the number of neighbor objects in the neighborhood domain of the object to be visited is larger than or equal to a corresponding predetermined threshold. If yes, the process proceeds to S251, at which the object to be visited is determined to be a core object. If the number of neighbor objects is not larger than or equal to the predetermined threshold (S241: “No”), the process proceeds to S261.

In the example shown in FIG. 6, the predetermined threshold is adjusted according to the weight coefficients, and thus is different from the predetermined threshold in the example shown in FIG. 5. Moreover, the predetermined threshold in the example shown in FIG. 6 is smaller than the predetermined threshold in the example shown in FIG. 5.

Consistent with the present disclosure, the neighborhood domains are checked successively in the ascending order of the scanning radii to determine whether the number of objects in a certain neighborhood domain satisfies the corresponding threshold requirement. If so, the number of the objects in the next neighborhood domain is not determined.

At S261, it is determined whether all of the plurality of neighborhood domains of the object to be visited have been checked. If so (S261: “Yes”), the process proceeds to S271, at which the object to be visited is determined to not be a core object. If all of the plurality of neighborhood domains have not been checked, then the process returns to S231 to check the next neighborhood domain. The determination at S261 is similar to that at S240 in FIG. 5, and thus details thereof are omitted here.

If the object P to be visited is not a core object, then the object P is the noise dot. The object to be visited is marked as visited and the process shown in FIG. 6 is repeated for next object to be visited, until no object to be visited is left.

FIG. 8 is a schematic diagram showing an exemplary clustering apparatus consistent with embodiments of the present disclosure. The apparatus shown in FIG. 8 includes a first obtaining unit 100, a first judging unit 200, a clustering unit 300, and an cluster expanding unit 400.

The first obtaining unit 100 is configured to obtain all neighbor objects of an object to be visited.

Consistent with the present disclosure, the object to be visited has a plurality of neighborhood domains. The first judging unit 200 is configured to determine whether there exists at least one neighborhood domain in which the number of neighbor objects is larger than or equal to a predetermined value. For example, the first judging unit 200 makes the determination in a manner similar to that described above in connection with S200 in FIG. 2 and the object to be visited shown in FIG. 3.

The clustering unit 300 is configured to cluster the object to be visited into one group, if there exists at least one neighborhood domain in which the number of neighbor objects is larger than the predetermined value.

The cluster expanding unit 400 is configured to perform cluster expansion on directly density-reachable objects in a predetermined neighborhood domain of the object to be visited, until no more neighbor objects are available to enter the group.

Details of the functions performed by the above units shown in FIG. 8 are similar to those described above in regard to the methods consistent with the present disclosure, and thus are not repeated here.

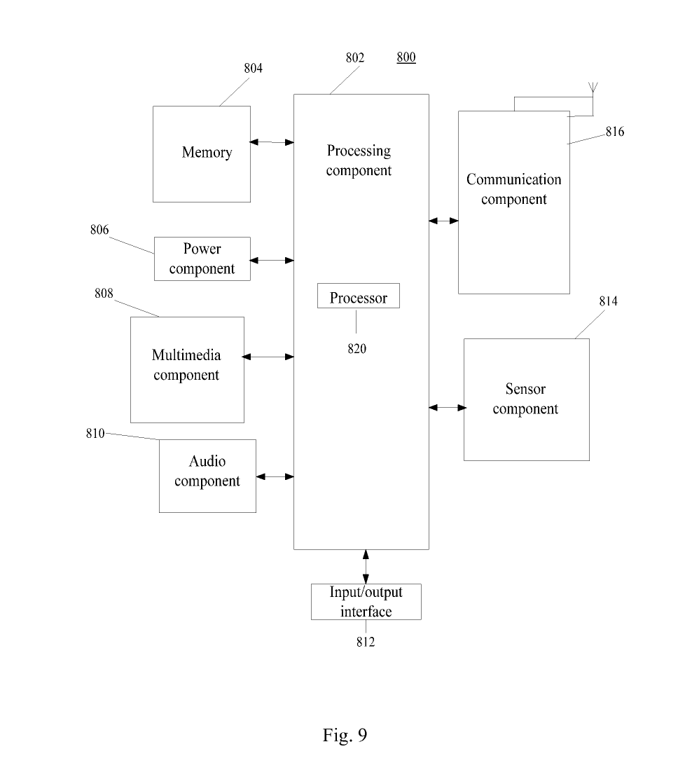

FIG. 9 is a block diagram showing an exemplary clustering apparatus 800, consistent with embodiments of the disclosure. For example, the apparatus 800 may be, for example, a mobile phone, a computer, a digital broadcast terminal, a messaging device, a gaming console, a tablet, a medical device, exercise equipment, a personal digital assistant, or the like.

Referring to FIG. 9, the apparatus 800 includes one or more of a processing component 802, a memory 804, a power component 806, a multimedia component 808, an audio component 810, an input/output (I/O) interface 812, a sensor component 814, and a communication component 816.

The processing component 802 controls overall operations of the apparatus 800, such as the operations associated with display, telephone calls, data communications, camera operations, and recording operations. The processing component 802 may include one or more processors 820 to execute instructions to perform all or part of the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the one or more processors 820 in the apparatus 800, for performing the above-described methods. For example, the non-transitory computer-readable storage medium may be a ROM, a RAM, a CD-ROM, a magnetic tape, a floppy disc, an optical data storage device, and the like.

In exemplary embodiments, there is also provided a device including a processor and a non-transitory computer-readable storage medium as described above.

It should be noted relational terms herein such as “first” and “second” are just intended to distinguish an entity or operation from another entity or operation, but not to imply any relationship or sequence between these entities or operations. Moreover, terms such as “include”, “comprise” or other variants are intended to cover a non-exclusive meaning, such that the process, method, object or apparatus including a series of elements may further include other elements which are not outlined definitely or include inherent elements of the process, method, object or apparatus. Unless specified otherwise, an element limited by a sentence “comprises a/an . . . ” does not exclude the possibility that the process, method, object or apparatus including the element may further include other identical elements.

It will be appreciated that the above embodiments are exemplary and the present disclosure is not limited thereto, and that various modifications and changes can be made without departing from the scope thereof. It is intended that the scope of the invention only be limited by the appended claims.

What is claimed is:

1. A clustering method, comprising:
obtaining neighbor objects of an object to be visited, the object to be visited having a plurality of neighborhood domains;
determining whether a number of neighbor objects in at least one of the neighborhood domains is larger than or equal to a predetermined value;
clustering the object to be visited into a group, if the number of neighbor objects in the at least one of the neighborhood domains is larger than the predetermined value; and
performing a cluster expansion on directly density-reachable objects in a predetermined neighborhood domain of the object to be visited.

2. The method according to claim 1, wherein determining whether the number of neighbor objects in the at least one of the neighborhood domains is larger than or equal to the predetermined value includes:
obtaining distances between the neighbor objects and the object to be visited; and
determining whether the number of neighbor objects in a first neighborhood domain is larger than or equal to the predetermined value according to the distances, the first neighborhood domain having a first scanning radius,
if the number of neighbor objects in the first neighborhood domain is larger than or equal to the predetermined value, determining the object to be visited to be a core object, and
if the number of neighbor objects in the first neighborhood domain is smaller than the predetermined value, determining whether all of the neighborhood domains have been checked,
if not all of the neighborhood domains have been checked, determining whether the number of neighbor objects in a second neighborhood domain is larger than or equal to the predetermined value according to the distances, the second neighborhood domain having a second scanning radius larger than the first scanning radius, and
if all of the neighborhood domains have been checked, determining the object to be visited to not be a core object.

3. The method according to claim 2, wherein determining whether the number of neighbor objects in the first neighborhood domain is larger than or equal to the predetermined value according to the distances includes:
sequencing the distances to obtain a distance sequence;
counting a number of neighbor objects having the distance smaller than the first scanning radius according to the distance sequence; and
determining whether the counted number is larger than or equal to the predetermined value.

4. The method according to claim 1, wherein determining whether the number of neighbor objects in the at least one of the neighborhood domains is larger than or equal to the predetermined value includes:
obtaining distances between the neighbor objects and the object to be visited;
obtaining weight coefficients corresponding to the distances;
calculating the number of neighbor objects in a first neighborhood domain according to the distances and the corresponding weight coefficients, the first neighborhood domain having a first scanning radius; and
determining whether the number of neighbor objects in the first neighborhood domain is larger than or equal to the predetermined value,
if the number of neighbor objects in the first neighborhood domain is larger than or equal to the predetermined value, determining the object to be visited to be a core object, and
if the number of neighbor objects in the first neighborhood domain is smaller than the predetermined value, determining whether all of the neighborhood domains have been checked,
if not all of the neighborhood domains have been checked:
calculating the number of neighbor objects in a second neighborhood domain according to the distances and the corresponding weight coefficients, the second neighborhood domain having a second scanning radius larger than the first scanning radius; and
determining whether the number of neighbor objects in the second neighborhood domain is larger than or equal to the predetermined value, and
if all of the neighborhood domains have been checked, determining the object to be visited to not be a core object.

5. The method according to claim 4, wherein obtaining the weight coefficients includes, for each distance between a neighbor object and the object to be visited:
obtaining a probability that the neighbor object is the same as the object to be visited; and
obtaining the weight coefficient by multiplying the distance and the probability.

6. The method according to claim 5, wherein:
obtaining the weight coefficients further includes obtaining a correspondence between distance between two objects and a probability that the two objects are the same, and
obtaining the probability that the neighbor object is the same as the object to be visited by querying the correspondence.

7. The method according to claim 1, wherein performing the cluster expansion includes:
obtaining the directly density-reachable objects in the predetermined neighborhood domain, a scanning radius of the predetermined neighborhood domain being smaller than a maximum scanning radius of the neighborhood domains;
determining whether the directly density-reachable objects in the predetermined neighborhood domain are core objects; and
for each directly density-reachable object in the predetermined neighborhood domain that is core object, adding neighbor objects of the directly density-reachable object in the predetermined neighborhood domain into the group.

8. A clustering apparatus, comprising:
an obtaining unit, configured to obtain neighbor objects of an object to be visited;
a judging unit, configured to determine whether a number of neighbor objects in at least one of the neighborhood domains is larger than or equal to a predetermined value;
a clustering unit, configured to cluster the object to be visited into a group, if the number of neighbor objects in the at least one of the neighborhood domains is larger than the predetermined value; and
a cluster expanding unit, configured to perform a cluster expansion on directly density-reachable objects in a predetermined neighborhood domain of the object to be visited.

9. A terminal apparatus, comprising:
a processor; and
a non-transitory computer-readable storage medium storing instructions that, when executed by the processor, cause the processor to:
obtain neighbor objects of an object to be visited having a plurality of neighborhood domains;
determine whether a number of neighbor objects in at least one of the neighborhood domains is larger than or equal to a predetermined value;
cluster the object to be visited into a group, if the number of neighbor objects in the at least one of the neighborhood domain is larger than the predetermined value; and
perform a cluster expansion on directly density-reachable objects in a predetermined neighborhood domain of the object to be visited.

10. A non-transitory computer-readable storage medium storing instructions that, when executed by a processor of a mobile terminal, cause the mobile terminal to:
obtain neighbor objects of an object to be visited having a plurality of neighborhood domains;
determine whether a number of neighbor objects in at least one of the neighborhood domains is larger than or equal to a predetermined value;
cluster the object to be visited into a group, if the number of neighbor objects in the at least one of the neighborhood domain is larger than the predetermined value; and
perform a cluster expansion on directly density-reachable objects in a predetermined neighborhood domain of the object to be visited.
